(19) United States
(12) Patent Application Publication
(10) Pub. No.: US 2023/0040969 A1
(43) Pub. Date: Feb. 9, 2023

(54) SITUATIONAL AWARENESS ROBOT

(71) Applicant: CO6, INC. DBA COMPANY SIX, Boulder, CO (US)

(72) Inventors: Paul BERBERIAN, Boulder, CO (US); Damon ARNIOTES, Lafayette, CO (US); Joshua SAVAGE, Hong Kong (CN); Andrew SAVAGE, Hong Kong (CN); Ross MACGREGOR, Erie, CO (US); David HYGH, Henderson, NV (US); James BOOTH, Niwot, CO (US); Jonathan CARROLL, Boulder, CO (US)

(21) Appl. No.: 17/789,298

(22) PCT Filed: Dec. 31, 2020
(86) PCT No.: PCT/US2020/067620

§ 371 Date: Jun. 27, 2022

Related U.S. Application Data
(60) Provisional application No. 62/956,948, filed on Jan. 3, 2020.

(51) Int. Cl. G05D 1/00; G05D 1/02; G06V 40/16

(52) U.S. Cl. CPC G05D 1/0038; G05D 1/0022; G05D 1/027; G05D 1/0212; G05D 1/0238; G05D 1/0246; G05D 1/0274; G06V 40/172; G05D 2201/0207; G05D 2201/0209

(57) ABSTRACT

A system and methods for assessing an environment are disclosed. A method includes causing a robot to transmit data to first and second user devices, causing the robot to execute a first action, and, responsive to a second instruction, causing the robot to execute a second action. At least one user device is outside the environment of the robot. At least one action includes recording a video of at least a portion of the environment, displaying the video in real time on both user devices, and storing the video on a cloud-based network. The other action includes determining a first physical location of the robot, determining a desired second physical location of the robot, and propelling the robot from the first location to the second location. Determining the desired second location is responsive to detecting a touch on a touchscreen video feed displaying the video in real time.

### CROSS-REFERENCE TO RELATED APPLICATIONS

This application claims priority to U.S. Provisional Application No. 62/956,948, filed Jan. 3, 2020 and entitled "Surveillance Robot," the entire disclosure of which is hereby incorporated by reference for all proper purposes.

### FIELD

This invention is related to robotics. Specifically, but not intended to limit the invention, embodiments of the invention are related to situational awareness robots.

### BACKGROUND

In recent years, various persons and organizations have increasingly relied on technology to monitor the safety conditions of people and property.

For example, homeowners rely on home monitoring systems having video and motion detection capabilities that enable the homeowners to monitor their homes from afar. Some systems include video and/or sound recording capabilities and some motion controls, such as locking or unlocking a door. See, for example, the home security systems and monitoring services offered by Ring LLC and SimpliSafe, Inc. These systems, however, are limited to stationary locations.

Law enforcement and/or military personnel similarly rely on remote-controlled devices to assess conditions from afar, such as the Throwbot™ product and service offered by ReconRobotics. The devices currently available offer remote monitoring. However, the operator must be within a relatively close range, and the Applicant is unaware of the above-described devices having any video recording capabilities.

There thus remains a need for a device or system capable of safely assessing the conditions of various locations or situations.

### SUMMARY

An exemplary system for assessing an environment has a robotic device having a propulsion mechanism, a wireless communication mechanism, and a tangible, non-transitory machine-readable media having instructions that, when executed, cause the robotic system to at least: (a) cause the robot to transmit situational data from an environment of the robot to a first user device and a second user device; (b) responsive to a first instruction from the first user device, cause the robot to execute a first action; and (c) responsive to a second instruction from the second user device, cause the robot to execute a second action. At least one of the first user device or the second user device is outside the environment of the robot. At least one of the first action or the second action includes: (a) recording a video of at least a portion of the environment, (b) displaying the video in real time on both the first user device and the second user device, and (c) storing the video on a cloud-based network. The other one of the first action or the second action includes: (a) determining a first physical location of the robot, (b) determining a desired second physical location of the robot, and (c) propelling the robot from the first location to the second location. The determining the desired second location is responsive to detecting a touch on a touchscreen video feed displaying the video in real time.

An exemplary computer-implemented method for assessing an environment includes: (a) causing a robot to transmit situational data from an environment of the robot to a first user device and a second user device; (b) responsive to a first instruction from the first user device, causing the robot to execute a first action; and (c) responsive to a second instruction from the second user device, causing the robot to execute a second action. At least one of the first user device or the second user device is outside the environment of the robot. At least one of the first action or the second action includes recording a video of at least a portion of the environment, displaying the video in real time on both the first user device and the second user device, and storing the video on a cloud-based network. The other one of the first action or the second action includes determining a first physical location of the robot, determining a desired second physical location of the robot, and propelling the robot from the first location to the second location, wherein the determining the desired second location is responsive to detecting a touch on a touchscreen video feed displaying the video in real time.

An exemplary method of using a robotic system includes providing a robot, providing a first user device having wireless communication with the robot, and providing a second user device having wireless communication with the robot. The method includes, on respective touchscreen user interfaces on the first user device and the second user device, displaying a live video feed of an environment of the robot. The method includes instructing the robot to move from a first location to a second location by touching a position on a first one of the respective touchscreen user interfaces. The method includes instructing the robot to move from the second location to a third location by touching a position on a second one of the respective touchscreen user interfaces.

### BRIEF DESCRIPTION ON THE DRAWINGS

FIG. 1 is a diagram of an exemplary system;

FIG. 2 is a detailed perspective view of features of an exemplary robot;

FIG. 3 is a side view of features of an exemplary robot;

FIG. 4 is a perspective view of features of an exemplary robot;

FIG. 5 is a flowchart of an exemplary method;

FIG. 6 is a diagram example of a user interface;

FIG. 7 is a top view of an exemplary robot in an environment before an action;

FIG. 8 is a top view of an exemplary robot illustrating a horizontal field of view;

FIG. 9 is a side view of an exemplary robot illustrating a vertical field of view;

FIG. 10 is a top view of an exemplary robot in an environment after an action;

FIG. 11 is a perspective view of an exemplary mount;

FIG. 12 is a perspective view of an exemplary mount and robot;

FIG. 13 is a side partial section view of an exemplary robot nearing an exemplary mount;

FIG. 14 is a side partial section view of the robot and mount in FIG. 12 midway through connection;

FIG. 15 is a side partial section view of the robot and mount in FIG. 14 in a connected state;

FIG. 16 is a side view of features of the robot and an exemplary module;

FIG. 17 is a side view of features of the robot and module in FIG. 16 in a connected state;

FIG. 18 is a side and rear view of an exemplary module;

FIG. 19 is a side view of an exemplary robot, docking station, and module in a coupled and decoupled state; and

FIG. 20 is a flow chart of an exemplary method.

### DETAILED DESCRIPTION

Before describing details of the invention disclosed herein, it is prudent to provide further details regarding the unmet needs in the presently-available devices. In one example, military, law enforcement, and other organizations currently assess the situation of locations of interest using such old-fashioned techniques as executing "stake-outs" with persons remaining in the location of interest, potentially exposed to harm. These organizations also recently have turned to the use of remote devices, such as those previously described herein. The currently-available devices, however, have limited communication capabilities, time-limited capabilities, among other areas of needed improvement. Homeowner security systems do not solve the problems presented, however.

Another exemplary problem involves the security of large spaces such as warehouses. It is notoriously difficult and expensive to maintain awareness of all areas of such spaces, as this would require the installation and monitoring of numerous cameras throughout, with blind spots a remaining problem.

The invention disclosed herein overcomes the previously-described problems by providing a device that allows one or more users to assess the situation of a remote location, and improves communication and time constraints, among other new and useful innovations.

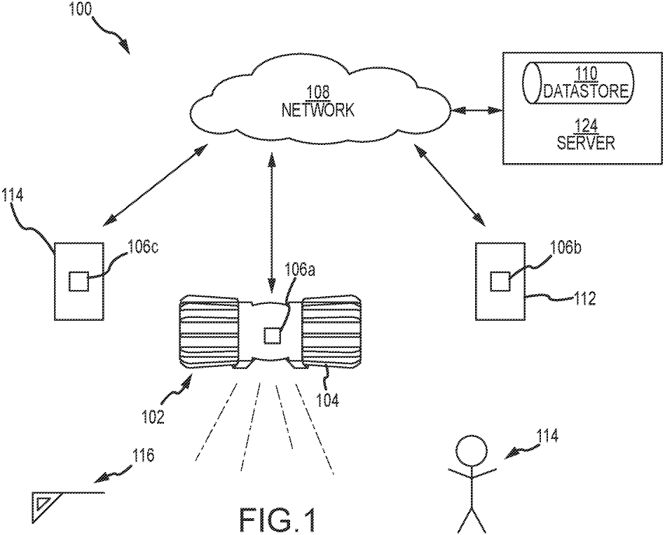

Turning now to FIG. 1, shown is an exemplary situational awareness system 100, which may be referenced herein as simply system 100. The system 100 may include a situational awareness robot 102 or robot 102 having a propulsion mechanism 104 and computer-readable media 106a comprising instructions which will be described in further detail in other portions of this document. The system 100 may include or access a cloud-based network 108 for the distribution or sharing of data or content through means known to those skilled in the art. The system 100 may include a datastore 110 such as a datastore 110 on a network server 124. Data collected or transmitted by the robot 102 may be saved on the cloud server 124 having a datastore 110. The server 124 may be operated by a third-party provider. The system 100 may further include a first user device 112 having media 106b and/or a second user device 114 having media 106c. The first and/or second user devices 112, 114 may be computing devices such as mobile telephones, mobile laptop computers or tablets, personal computers, or other computing devices. In some embodiments, the system 100 may include a person or face 114 recognizable by the robot 102, or the system 100 may be configured to recognize the face. In some embodiments, the system 100 may include an object 116 recognizable by the robot 102, or the system may be configured to recognize the object 116. The system 100 may be configured to map at least one room (not illustrated) in some embodiments.

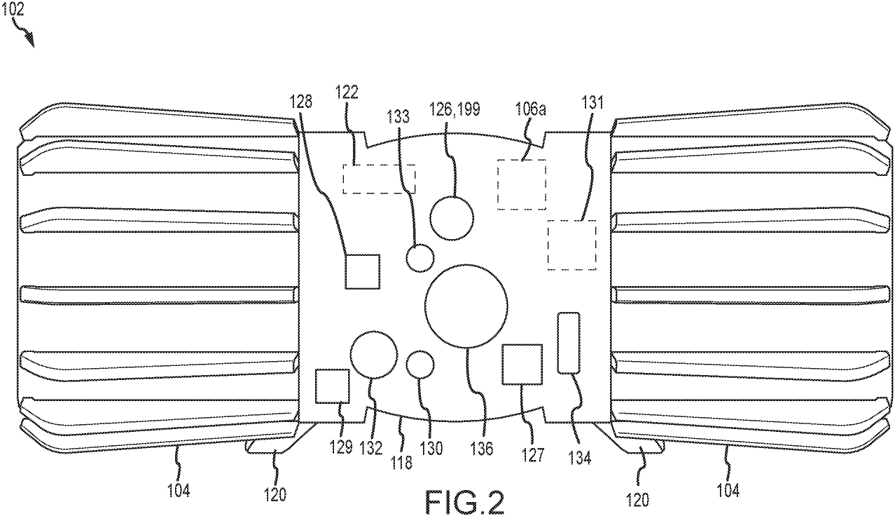

Turning now to FIG. 2, shown is a detailed view of an exemplary robot 102, which may be suitable for use in the system 100 described herein. The robot 102 may have a propulsion mechanism 104 coupled to a base 118. The propulsion mechanism 104 may include a rotating mechanism for moving the base 118. The base 118 may include, couple to, or house a stabilizing mechanism 120, media 106a, an antenna 122, a communication mechanism 128, a microphone 130, and/or an infrared light 132. In some embodiments, the robot 102 has a light 133. The light 133 may be a bright light such as a bright LED light 133. The light 133 may be used to illuminate the environment to improve visibility for users of the user device(s) 112, 114. The light 133 may be used or configured to attract the attention of persons or animals in the environment by flashing.

In some embodiments, the robot 102 has an Inertial Measurement Unit (IMU) and a control system configured to stabilize and orient the robot 102. The IMU enables operators, which may be operating the user device(s) 112, 114 or others, to control or navigate the robot 102. In some embodiments, the robot 102 has a satellite navigation system 131, which may be a Global Positioning System (GPS) and/or a Global Navigation Satellite System (GNSS), to enable a user device 112, 114 to track a location of the robot 102 and/or effectuate a movement of the robot 102 between a first location and a second location as is discussed in other sections of this document.

The robot 102 or communication mechanism 128 may include a Long-Term Evolution (LTE) broadband communication mechanism.

The robot 102 may include a high-definition camera 126 and/or a time-of-flight sensor 199. The robot 102 may include a sensor package 127 having a motion sensor, a distance sensor such as a time-of-flight sensor 199, and a 9-axis inertial measurement unit; and a network access mechanism which may be the communication mechanism 128 or a separate network access mechanism 129. The sensor package 127 may include other sensors to assist in locating the robot 102 and/or obstructions.

The antenna 122 may be integral to the robot 102, such as integral to the base 118 or circuitry (not illustrated) housed in the base 118, though those skilled in the art will recognize that the antenna may be integral to the propulsion mechanism 104. For the purpose of this disclosure, the term "integral" when referencing the antenna shall be understood to mean an antenna that does not protrude beyond a visual profile of the base 118. Those skilled in the art will recognize, of course, that the antenna 122 may be external, such as a whip antenna. It is believed, however, that an integral antenna 122 may allow the robot 102 to assess a broader range of environments without disturbing the environments.

The communication mechanism 128 may include a radio, network, or wireless communication means to enable communication between the robot 102, the network 108, and/or the first and/or second user devices 112, 114. A microphone 130 may facilitate communication such as by enabling a 2-way communication between a user 112, 114 and, for example, a person 114 in the environment of the robot 102.

The robot 102 may include an infrared (IR) light 132 such as an IR floodlamp to improve visibility in low visibility situations.

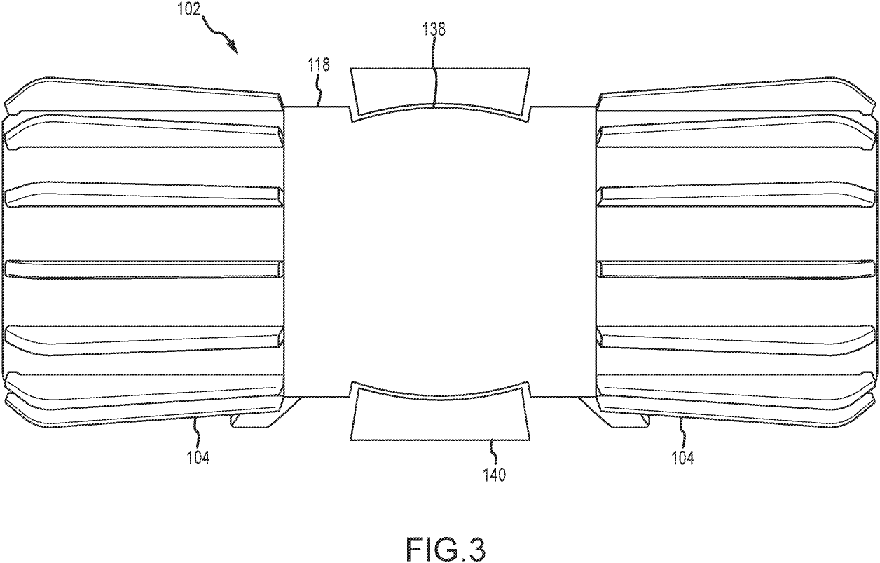

Turning now to FIG. 3, the robot 102 or the base 118 may be shaped or configured to removably attach to a user's belt or another device. For example, the base 118 may be shaped to engage one or more resilient members 140 on a user's belt to provide a snap-fit engagement between the robot 102 and the belt (not shown). The base 118 may have one or more recesses 138 to receive the resilient member(s) 140.

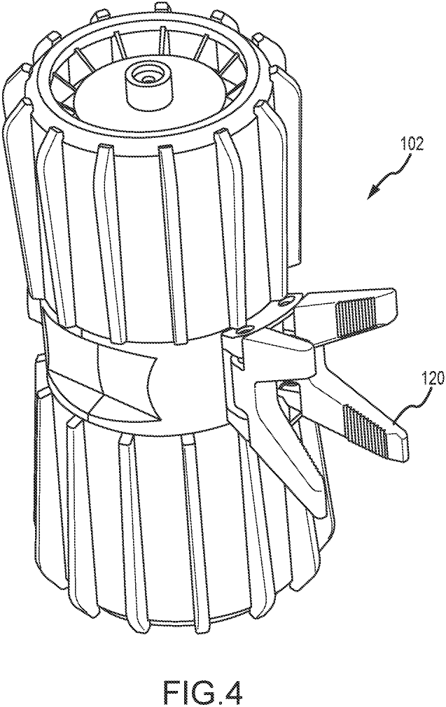

Turning now to FIG. 4, which illustrates the robot 102, the stabilizing mechanism 120 may include one or more legs 121. The leg(s) 121 may be movable relative to the base 118 to create a smaller footprint or profile during storage, but still allow the leg(s) 121 to extend away from the base 118 to stabilize the robot 102 during use. The leg(s) 121 may also be movable to allow the robot 102 to be stored more easily on a belt or resilient member 140, as shown in FIG. 3.

In some embodiments, a plurality of legs 121 as shown may increase agility of the robot 102 while maintaining an ideal viewing angle for the camera 126 and/or ideal sensing angles for other devices in the sensing package 127.

In some embodiments, while docked, the legs 121 may be forced into an open position. The stabilizing mechanism may include a biasing mechanism such as a spring to create an ejection force from a charging dock. The user may push a release button on the dock and cause the product to eject softly.

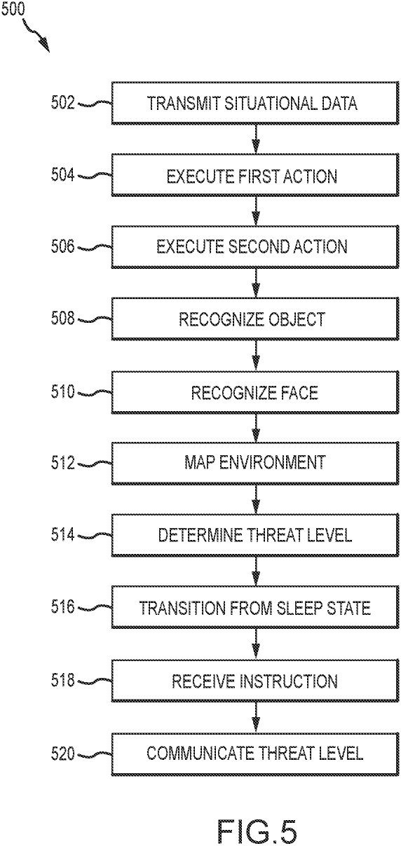

In some embodiments, the media 106a, 106b, 106c illustrated in FIG. 1 may include a tangible, non-transitory machine-readable media 106a, 106b, 106c comprising instructions that, when executed, cause the system 100 to execute a method, such as the method 500 illustrated in FIG. 5.

The method 500 may include transmitting 502 situational data, which may include causing the robot 102 to transmit situational data from an environment of the robot to a first user device 112 and a second user device 114. Transmission may be by way of a wireless network 108 such as a Wide Area Network (WAN), a Long-Term Evolution (LTE) wireless broadband communication, and/or communication means. The data may include video, acoustic, motion, temperature, vibration, facial recognition, object recognition, obstruction, and/or distance data.

The method 500 may include executing 504 a first action. Executing 504 may include, responsive to a first instruction from the first user device 112, causing the robot 102 to execute a first action.

The method 500 may include executing 506 a second action. Executing 506 may include, responsive to a second instruction from the second user device 114, causing the robot 102 to execute a second action.

At least one of the first user device 112 or the second user device 114 may be outside the environment of the robot 102. At least one of the first action or the second action may include recording a video of at least a portion of the environment and storing the video on a cloud-based network. The other one of the first action or the second action may include propelling the robot from a first location to a second location.

The method 500 may include recognizing 508 at least one object, which may include causing the robot 102 to recognize at least one object. The object may be a dangerous object such as a weapon, a facility, a room, or another object using means known to those skilled in the art.

The method 500 may include recognizing 510 at least one face of a human, which may include causing the robot 102 to recognize at least one face.

The method 500 may include mapping 512 at least a portion of the environment, which may include causing the robot 102 to map at least a portion of the environment.

The method 500 may include determining 514 a threat level. In some embodiments, the threat level may be determined by media 106a within the robot 102. The determining 514 may be responsive to recognizing 510 at least one face or recognizing 508 at least one object, or both.

The method 500 may include communicating 520 the threat level to at least one of the first user device or the second user device, which may include causing the robot 102 to communicate 520 the threat level.

At least one of the first action or the second action may include transmitting 2-way audio communications between the robot and at least one of the first user device or the second user device.

The method 500 method may include, responsive to at least one of a motion in the environment or an acoustic signal in the environment, transitioning 516 from a sleep state to a standard power state, which may include causing the robot 102 to transition from a sleep state to a standard power state.

The method 500 may include receiving 518 instructions from both a first user device 112 and a second user device 114.

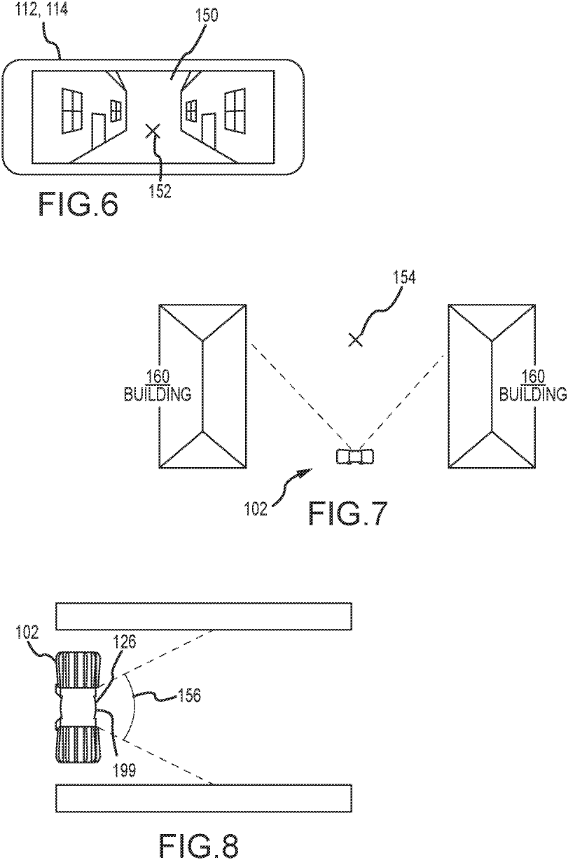

Turning now to FIGS. 6 through 10, details of a user interface and robot control mechanisms are now described herein. In FIG. 6, shown is a user device 112, 114 such as the first and second user devices 112, 114 previously described herein. The particular user device 112, 114 illustrated in FIG. 6 is a mobile phone, though those skilled in the art will recognize that the user device 112, 114 may be any suitably-adapted computing device.

The user device 112, 114 may have a user interface such as a touch screen video interface 150. The user device 112, 114 may receive situational data from the robot 102, such as when the robot 102 executes the method 500 described herein. The situational data may include a live video feed of the robot environment, and the user device 112, 114 may display the live video. In some embodiments, the touch screen video interface 150 may allow a user to touch a position 152 on the screen to instruct the robot 102 to move. As illustrated in FIG. 7, the robot 102 may be configured to extrapolate a defined physical location 154 from the position 152 touched by the user. The robot 102 may respond by moving to the physical location 154 correlating to the position 152 touched by the user.

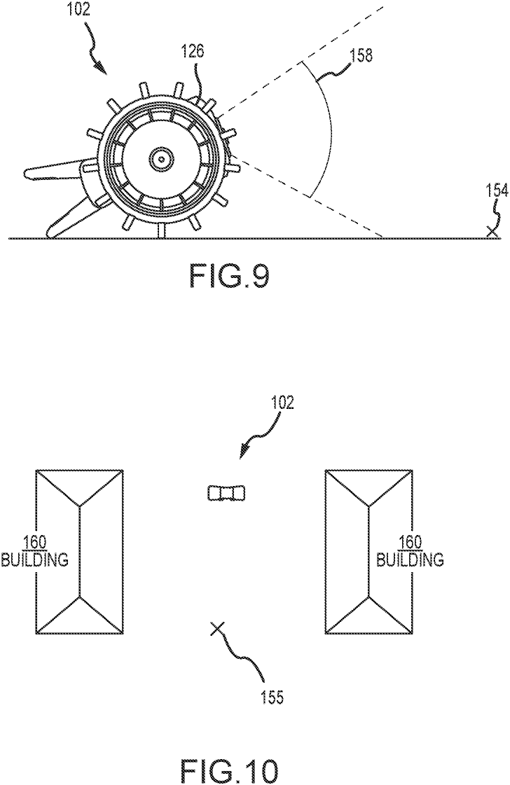

Relatedly, and with brief reference to FIG. 5, FIG. 6, and FIG. 9, the method 500 may include executing 504 a first action, wherein the executing 504 includes determining an instruction to move from a first position to a second position, wherein the second position is a desired defined physical location 154, and moving from the first position to the second position. The determining an instruction to move from a first position to a second position may include extrapolating a defined physical location 154 from a position 152 on a screen of a user device 112, 114. The determining may include determining a desired defined physical location is inaccessible such as within or behind an obstruction, such as a building 160, and ignoring the instruction or alerting the user that the defined physical location 154 is inaccessible.

Those skilled in the art will recognize that the camera 126 and/or the time-of-flight sensor 199 may have a defined horizontal field of view 156 (see e.g. FIG. 8) and a vertical field of view 158 (see e.g. FIG. 9). The robot 102 and/or media 106a, 106b, 106c may be configured to calculate a distance between the robot 102 and other objects or between a plurality of objects.

Turning now to FIG. 8 and FIG. 9, and as previously described herein, the robot 102 may include a camera 126 and time-of-flight sensor 199 to improve navigation capabilities of the robot 102. For example, the robot 102 and/or media 106a, 106b, 106c may be configured to derive a desired defined physical location 154 by analyzing data from the sensor 199, the camera 126, and the position 152. The robot 102 and/or media 106a, 106b, 106c may be configured to assign X,Y coordinates to a desired defined physical location 154 as well as to a current physical location 155 (see e.g. FIG. 10 and FIG. 7) of the robot 102. The robot 102 and/or media 106a, 106b, 106c may be configured to determine the existence, location or coordinates of one or more obstructions, such as a building or buildings 160. The method 500 may include disregarding an instruction to move through an obstruction, such as by determining the user has touched a position 152 on the screen that is part of an obstruction.

With continued reference to FIGS. 6-10, the robot 102 and/or media 106a, 106b, 106c may be configured to derive a desired physical location 154 defined by user-touched position 152 by analyzing data associated with the current physical location 155 and data gathered from the camera 126, sensor 199, and/or sensor package 127.

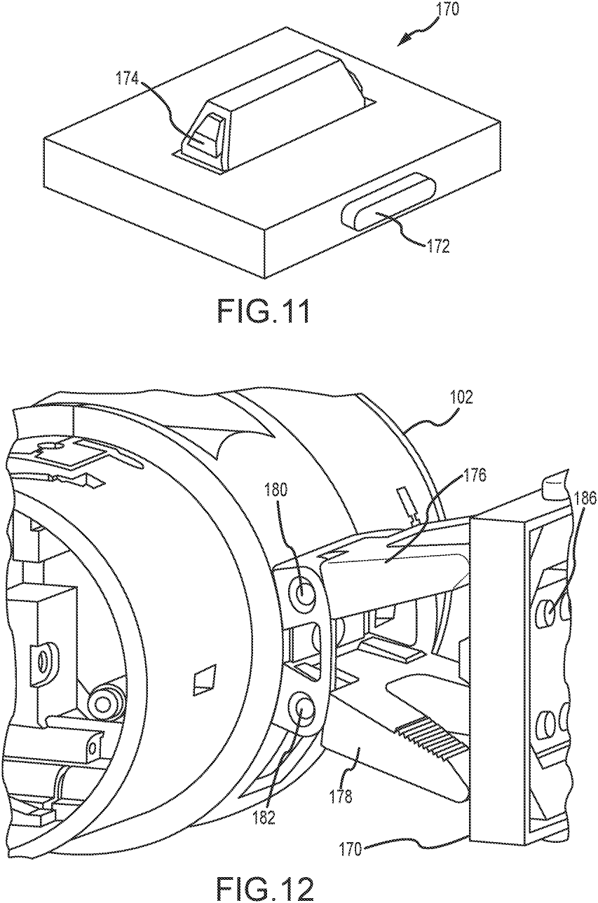

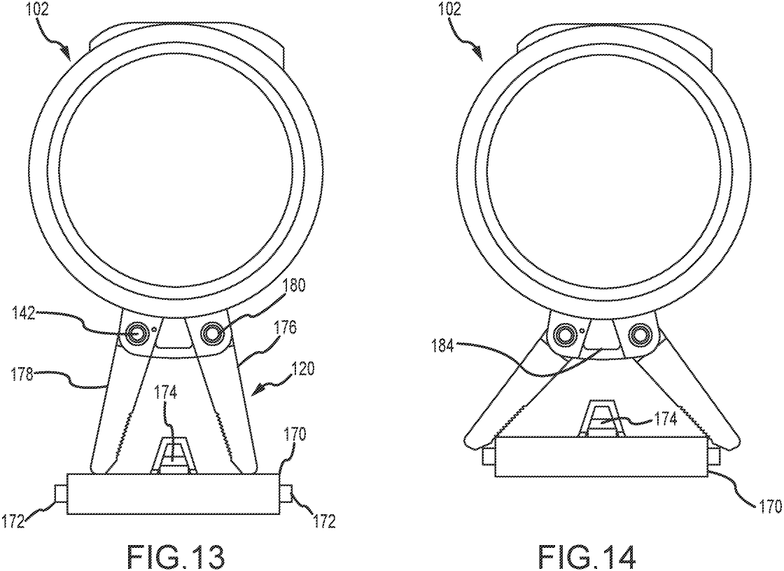

Turning now to FIGS. 11 through 15, an exemplary mount 170 is described herein. The mount 170 may include, for example, one or more resilient members 174 to engage one or more recesses 184 in the robot 102. The resilient member 174 may be detent mechanisms known to those skilled in the art. The mount 170 may include one or more release mechanism 172, such as a mechanism to retract the resilient members 174 from the recess 184 to allow the robot 102 to be removed from the mount 170. The mount 170 may include an attachment mechanism 186 to facilitate temporary or permanent attachment of the mount 170 to another object, such as a user’s belt, a wall, a vehicle component, or other location, using any means suitable and known to those skilled in the art. The recess 184 may be coupled to the base 118 of the robot 102.

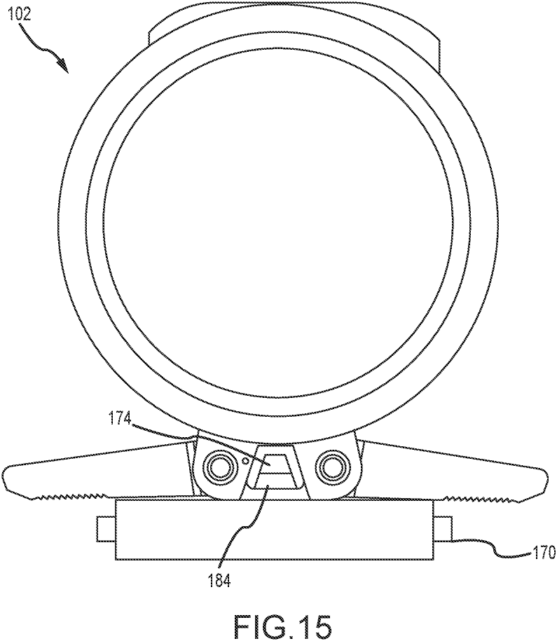

In some embodiments, the stabilizing mechanism 120 may include a first leg member 176 and a second leg member 178 movable relative to pivot points 180, 182 to facilitate attaching the robot 102 to a mount 170. A biasing mechanism (not shown) such as a spring may be provided to bias the leg members 176, 178 toward one another. When a user presses the robot 102 against the mount 170, the pressure may force the leg members 176, 178 apart to allow the robot 102 to attach to the mount 170 as shown in FIG. 15. To release, the user may activate the release mechanism 172 to eject the robot 102.

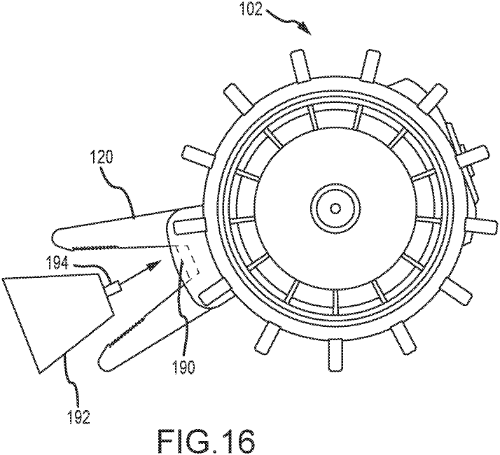

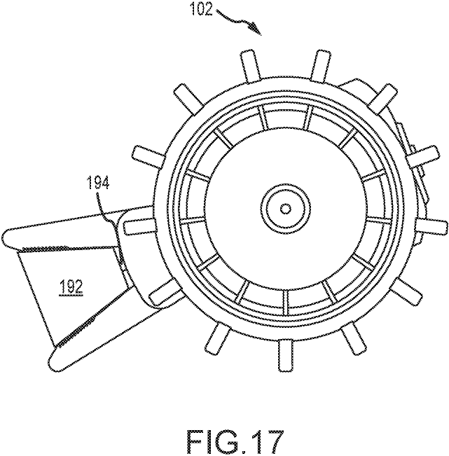

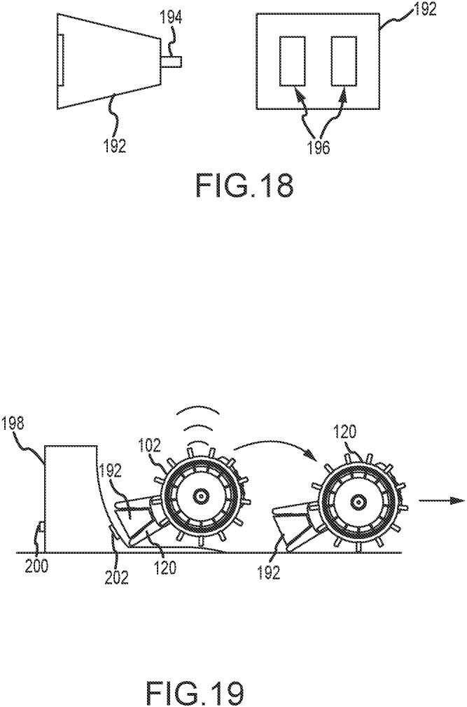

Turning now to FIG. 16 and FIG. 17, an exemplary module 192 is described. The module 192 may be configured to provide the robot 102 with enhanced capabilities. The enhanced capabilities may include, without limitation, enhanced computing storage or capability, enhanced physical storage (such as storing an object for delivery to the environment), docking capability (which is discussed with reference to FIGS. 18-19 in other portions of this document), enhanced sensors, accessory sensors, accessory robot device, etc.

The module 192 may include a connector 194 configured to engage a complementary connector 190 on the robot 102 such as on the base 118. The module 192 may be shaped to fit within the envelope of the stabilizing mechanism 120 so as to not increase the footprint of the robot 102 and/or to not destabilize movement of the robot 102. See, e.g., an exemplary robot 102 in FIG. 17 in a deployed state, wherein the module 192 is housed/protected by the stabilizing mechanism 120 while the robot 102 is moving along a surface.

When the module 192 includes enhanced capabilities that require electrical communication, the connector 194 may be or include, for example, a USB connection or any other connector 194 and complementary connector 190 suitable for the transfer of power and/or data.

In some embodiments, and as best shown in FIG. 18 and FIG. 19, the module 192 may provide a charging means. For example, the module 192 may include a connector 194 such as a USB connector for coupling to the robot 102 and a charging mechanism 196 such as charging pads known to those skilled in the art. The system 100 referenced in FIG. 1 may include a docking station 198 with access to a power source 200 such as a wall plug. The robot 102 may be configured to dock at the docking station 198 in response to a determination that the robot 102 is low on power, in response to a user instruction, or in response to a determination that no action is required, such as when the robot 102 is entering a rest or sleep state. When docked, the charging mechanism 196 such as charging pads engage power contacts 202 on the docking station 198 to charge.

In some embodiments, the module 192 is configured to move with the robot 102, as shown in FIG. 19.

Those skilled in the art will recognize that the docking station 198 may be configured to receive and/or charge a plurality of robots 102 and the system 100 may include a plurality of robots 102. For example, a plurality of robots 102 may be used to maintain security of products stored in a very large warehouse.

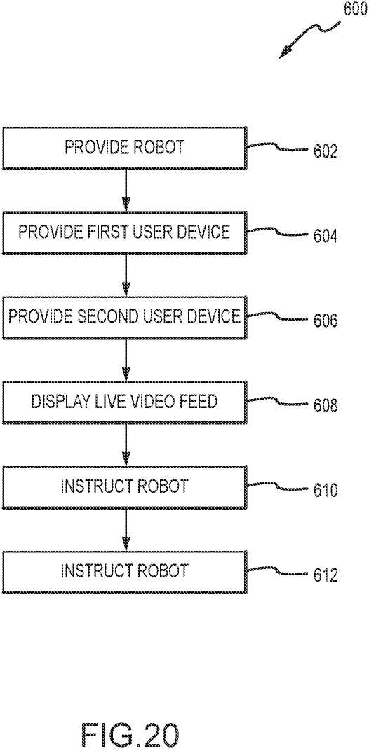

Turning now to FIG. 20, a method 600 of using a robotic system is described. The method 600 may be carried out using the robot system 100 and/or the components described herein. The method 600 includes providing 602 a robot. The method 600 includes providing 604 a first user device having wireless communication with the robot. The method 600 includes providing 606 a second user device having wireless communication with the robot. The method 600 may include, on respective touchscreen user interfaces on the first user device and the second user device, displaying 608 a live video feed of an environment of the robot. The method 600 may include instructing 610 the robot to move from a first location to a second location by touching a position on a first one of the respective touchscreen user interfaces. The method 600 may include instructing 612 the robot to move from the second location to a third location by touching a position on a second one of the respective touchscreen user interfaces. The method 600 may include performing some or all of the method 500 described herein.

Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, the disclosure of a "fastener" should be understood to encompass disclosure of the act of "fastening" —whether explicitly discussed or not—and, conversely, were there only disclosure of the act of "fastening", such a disclosure should be understood to encompass disclosure of a "fastening mechanism". Such changes and alternative terms are to be understood to be explicitly included in the description.

Moreover, the claims shall be construed such that a claim that recites "at least one of A, B, or C" shall read on a device that requires "A" only. The claim shall also read on a device that requires "B" only. The claim shall also read on a device that requires "C" only.

Similarly, the claim shall also read on a device that requires "A+B". The claim shall also read on a device that requires "A+B+C", and so forth.

The claims shall also be construed such that any relational language (e.g. perpendicular, straight, parallel, flat, etc.) is understood to include the recitation "within a reasonable manufacturing tolerance at the time the device is manufactured or at the time of the invention, whichever manufacturing tolerance is greater".

Those skilled in the art can readily recognize that numerous variations and substitutions may be made in the invention, its use and its configuration to achieve substantially the same results as achieved by the embodiments described herein.

Accordingly, there is no intention to limit the invention to the disclosed exemplary forms. Many variations, modifications and alternative constructions fall within the scope and spirit of the invention as expressed in the claims.

1. A system for assessing an environment, comprising:
a robotic device having a propulsion mechanism coupled to a base, the base having an Inertial Measurement Unit and an attachment mechanism configured to removably attach the robot to a user's utility belt, the robotic device further having a Long-Term Evolution broadband communication mechanism;
a wireless communication mechanism; and
a tangible, non-transitory machine-readable media comprising instructions that, when executed, cause the robotic system to at least:
cause the robot to transmit situational data from an environment of the robot to a first user device and a second user device;
responsive to a first instruction from the first user device, cause the robot to execute a first action; and
responsive to a second instruction from the second user device, cause the robot to execute a second action; wherein
at least one of the first user device or the second user device is outside the environment of the robot;
at least one of the first action or the second action comprises recording a video of at least a portion of the environment, displaying the video in real time on both the first user device and the second user device, and storing the video on a cloud-based network;
the other one of the first action or the second action comprises determining a first physical location of the robot, determining a desired second physical location of the robot, and propelling the robot from the first location to the second location, wherein the determining the desired second location is responsive to detecting a touch on a touchscreen video feed displaying the video in real time.

2. The system of claim 1, wherein:
the situational data comprises at least one of video, acoustic, motion, temperature, vibration, or distance data of the environment.

3. The system of claim 1, wherein:
the robot comprises a control system configured to stabilize and orient the robot.

4. The system of claim 3, wherein:
the robot comprises:
a high definition camera;
a sensor package having a motion sensor, a distance sensor, and a 9-axis inertial measurement unit; and
a network access mechanism.

5. The system of claim 1, wherein:
the instructions when executed by the one or more processors cause the one or more processors to:
recognize at least one obstruction;
recognize at least one object;
map at least a portion of the environment; and
recognize at least one face.

6. The system of claim 1, wherein:
the instructions when executed by the one or more processors cause the one or more processors to:
at least one of recognize at least one face or recognize at least one object;
responsive to the recognizing, determine a threat level presented by the at least one person, the at least one object, or both, and communicate the threat level to at least one of the first user device or the second user device.

7. The system of claim 1, wherein:
the robot comprises at least one infrared light flood-lamp.

8. The system of claim 1, wherein:
the instructions when executed by the one or more processors cause the one or more processors to:
transmit 2-way audio communications between the robot and at least one of the first user device or the second user device.

9. The system of claim 1, wherein:
the robot comprises
a detachable module.

10. The system of claim 1, wherein:
the instructions when executed by the one or more processors cause the one or more processors to:
responsive to at least one of a motion in the environment or an acoustic signal in the environment, cause the robot to transition from a sleep state to a standard power state.

11-21. (canceled)

22. The system of claim 1, wherein:
the robot further comprises a stabilizing mechanism having one or more legs coupled to and movable relative to the base between a first position for storage and a second position for stabilizing the robot during use.

23. The system of claim 4, wherein:
the robot further comprises a stabilizing mechanism having one or more legs coupled to and movable relative to the base between a first position for storage and a second position for stabilizing the robot during use; and wherein
the one or more legs are configured to maintain an ideal viewing angle for the camera during use.

24. The system of claim 1, wherein:
the instructions, when executed, cause the robotic system to recognize at least one object, the at least one object being a dangerous object.
